(19) United States
(12) Patent Application Publication
(10) Pub. No.: US 2013/0159195 A1
(43) Pub. Date: Jun. 20, 2013

(54) AUTHENTICATION OF DEVICES

(71) Applicants: Viacheslav Kirillin, St. Petersburg (RU); Sergey Zemlyanskiy, St. Petersburg (RU)

(72) Inventors: Viacheslav Kirillin, St. Petersburg (RU); Sergey Zemlyanskiy, St. Petersburg (RU)

(73) Assignee: RAWLLIN INTERNATIONAL INC., Tortola, VI (US)

(21) Appl. No.: 13/328,204

(22) Filed: Dec. 16, 2011

(51) Int. Cl. G06Q 20/40

(52) U.S. Cl. 705/71

(57) ABSTRACT

Disclosed are systems and techniques that authenticate and authorize a mobile device to conduct transactions over a network with a banking server. Once a mobile device is authenticated, the server generates a client device identifier and a secret key, which is then stored on the mobile device. In response to a transaction request sent by the mobile device, the server authorizes a session by generating a random code and communicates the random code to the mobile device. By using a combination of the secret key and the random code, the mobile device generates two keys, a hash code and a symmetrical key. The server receives the hash code and the unique client device identifier, and based upon a determination, authorizes the transaction on the banking server.

### TECHNICAL FIELD

The subject application relates generally to the field of authentication of mobile devices, and more particularly to methods and systems for authenticating a client device or system with a network server.

### BACKGROUND

Legal and technical challenges exist with respect to protection of customer information, increasing incidents of fraud in banking sectors such as identity theft, and the introduction of authentication technologies. Banks are recommended to conduct risk-based assessments, evaluate customer awareness programs, and develop security measures to reliably authenticate customers remotely accessing their internet-based financial services.

Agencies consider single-factor authentication, as the only control mechanism, to be inadequate for high-risk transactions involving access to customer information or the movement of funds to other parties. Financial institutions offering Internet-based products and services to their customers should use effective methods to authenticate the identity of customers using those products and services. The authentication techniques employed by the financial institution should be appropriate to the risks associated with those products and services. Account fraud and identity theft are frequently the result of single-factor (e.g., ID/password) authentication exploitation. Where risk assessments indicate that the use of single-factor authentication is inadequate, financial institutions should implement multifactor authentication, layered security, or other controls reasonably calculated to mitigate those risks.

There are a variety of technologies and methodologies financial institutions can use to authenticate customers. These methods include the use of customer passwords, personal identification numbers (PINs), digital certificates using a public key infrastructure (PKI), physical devices such as smart cards, one-time passwords (OTPs), USB plug-ins or other types of “tokens”, transaction profile scripts, biometric identification, and others. The level of risk protection afforded by each of these techniques varies.

With the growth in electronic banking and commerce, financial institutions should use reliable methods of originating new customer accounts online. Moreover, customer identity verification during account origination is required by some law and is important in reducing the risk of identity theft, fraudulent account applications, and unenforceable account agreements or transactions. Potentially significant risks arise when a financial institution accepts new customers through the Internet or other electronic channels.

The above-described challenges of today's banking sectors lend for the need to better serve clients by providing better authentication security for the clients and devices, in which the client transacts with. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for authenticating mobile devices for transactions on a banking server are contained herein. An exemplary method comprises receiving, at a banking server that stores financial information related to one or more user accounts, a log-in request from a mobile device of a user with at least one user account of the one or more user accounts. The method includes determining an authentication level of the mobile device, and in response to determining that the authentication level of the mobile device meets a condition for a predetermined function, authenticating the mobile device and generating a first authorization factor and a second authorization factor. The method includes storing the first authorization factor and the second authorization factor to the mobile device, and generating a first code and communicating the first code to the mobile device in response to receiving a transaction request from the mobile device. The first authorization factor and a second code are received from the mobile device. The method further includes authorizing the mobile device to conduct a transaction with the one or more user accounts.

In another non-limiting embodiment, an exemplary system comprises a banking server including a customer financial data store having financial information related to one or more user accounts stored on the banking server. An authentication factor component of the system is configured to authenticate a mobile device and provide at least two authentication factors to the mobile device in response to a transaction request to initiate an online transaction with the mobile device, and a code generator is of the system configured to generate a random code that is associated with the transaction request and communicate the random code to the mobile device in response to the transaction request. The authentication factor component is further configured to receive at least one authentication factor of the at least two authentication factors, a first code function and an encrypted bank transaction message from the mobile device, calculate a second code function, provide a comparison of the first code function with the second code function and determine an authorization associated with a transaction.

In still another non-limiting embodiment, an exemplary computer readable storage medium comprising computer executable instructions that, in response to execution, cause a computing system to perform operations. The operations comprise receiving, at a banking server that stores financial information related to one or more user accounts, a log-in request from a client device of a user having at least one user account of the one or more user accounts, determining an authentication level of the client device. In response to determining that the authentication level of the client device is below a condition for a predetermined function, the operations comprise authenticating the client device and generating a client device identifier and a secret key. The operations include storing the client device identifier and the secret key to the client device, generating a first random code and communicating the first random code to the client device in response to receiving a transaction request from the client device, receiving the client device identifier and a first hash code from the client device in response to communicating the first random code, determining an authorization level associated with a transaction that is requested in the transaction request based on a calculation of a second hash code with values stored on the banking server for the secret key and the first random code and a comparison of the first hash code and the second hash code, and authorizing the client device to conduct the transaction with the one or more user accounts as a function of the authorization level.

In still yet another non-limiting embodiment, an exemplary system comprises means for receiving, at a banking server that stores financial information related to one or more user accounts, a log-in request from a mobile phone of a user having at least one user account of the one or more user accounts, means for determining an authentication level of the mobile phone, means for generating a mobile phone identifier and a secret key that is associated with the mobile phone and storing the mobile phone identifier and the secret key to the mobile phone, means for authorizing the mobile phone to execute a transaction associated with the one or more user accounts that includes means for forming a first random code and communicating the first random code to the mobile phone in response to receiving a transaction request from the mobile phone, and means for receiving the mobile phone identifier and a first hash code from the mobile phone in response to communicating the first random code. The means for authorizing includes determining an authorization level associated with the transaction that is requested in the transaction request based on a calculation of a second hash code with values stored on the banking server for the secret key and the first random code and a comparison of the first hash code and the second hash code.

In still yet another non-limiting embodiment, an exemplary method comprises generating a log-in request, by a mobile device, to access at least one user account of one or more user accounts of a banking server and to execute a transaction related to the at least one user account of one or more user accounts. In response to the log-in request, a mobile device identifier and a secret key are received that are associated with the mobile device from the banking server. The method includes generating a transaction request to execute the transaction, and in response to the transaction request, receiving a random number from the banking server. The method includes calculating a symmetrical key and a hash code based on a combination of the secret key and the random number, generating an encrypted message with the symmetrical key, communicating the encrypted message and the hash code to the banking server, and executing the transaction related to the at least one user account of one or more user accounts in response to an authorization provided by the banking server based on the encrypted message and the hash code.

In still yet another non-limiting embodiment, an exemplary mobile device comprises an interface component configured to generate a log-in request and receive, from a banking server, a mobile device identifier and a secret key that are unique to the mobile device in response to the log-in request. A cryptographic engine of the mobile device is configured to generate a hash code and a symmetrical key with a received random number from the banking server and generate an encrypted message, and a communication module is configured to communicate the hash code, the encrypted message and the mobile device identifier to the banking server, and to receive an authorization to execute a transaction in response to a transaction request.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an exemplary system in accordance with various aspects described herein;

FIG. 2 illustrates another exemplary system for authenticating and authorizing a client device in accordance with various aspects described herein;

FIG. 3 illustrates another exemplary system for authenticating and authorizing a mobile phone in accordance with various aspects described herein;

FIG. 4 illustrates another exemplary system for authenticating and authorizing a mobile device in accordance with various aspects described herein;

FIG. 5 illustrates an example key generator in accordance with various aspects described herein;

FIG. 6 illustrates an exemplary aspect of a viewing pane for a client device in accordance with various aspects described herein;

FIG. 7 illustrates a flow diagram showing an exemplary non-limiting implementation for a banking system in accordance with various aspects described herein;

FIG. 8 illustrates a flow diagram showing an exemplary non-limiting implementation for a client device in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

In consideration of the above-described deficiencies, among other things, various embodiments are provided that authenticate a client or user on a banking server. A banking server, for example, generates and provides authentication factors that are communicated to a client and stored on the client's device, such as a personal computer, laptop, wireless device, mobile telephone, mobile device, personal digital assistant, iPod, and the like. The banking server includes an authentication factor generator that responds to a user desiring to conduct a transaction with an online account. The account is stored, for example, in a data store, such as a database, such as a financial database that has user accounts maintained by a bank computer system that operates the banking server.

In response to a request from the user over a mobile device, the banking server determines whether the device has been authenticated for accessing online banking. Based on the determination, the server generates a device identifier that is unique to the particular device used to conduct online activity with the server, as well as generates a key. The key can be a certificate signed with a private or public key, or only a secret key. The server stores the client device identifier and the key onto the mobile device, which enables a further authorization process when the client desires to conduct a transaction on the device with one or more accounts stored by the banking server on a financial database. Embodiments are detailed further below in reference to the accompanying figures.

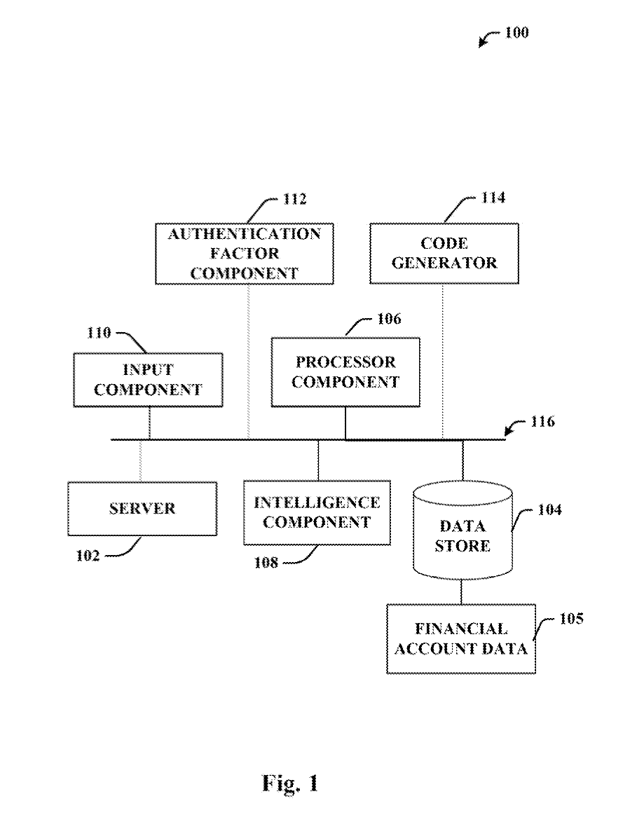

Referring initially to FIG. 1, illustrated is an example system 100 that authorizes banking operations without a signature. For example, banking operations include bank operations data related to any number of banking activities or products such as transactions with checking accounts, savings accounts, money market accounts, Certificate of Deposits (CD's), Individual Retirement Accounts (IRA's), credit cards, debits cards, mortgages, home equity loans, mutual funds, personal loans, business loans, capital raising, mezzanine finance, project finance, revolving credit, risk management, term loans, cash management servers, and the like. The system 100 includes a banking authentication system that enables transactions related to banking operations to be conducted with a client device, such as a mobile device from a remote location.

The system 100 comprises a server 102, a data store 104 for storing instructions that are executed via a processor component 106. The system 100 includes an intelligence component 108, an input component 110, an authentication factor component 112 and a code generator 114. The system 100 and server 102 can be configured in a number of other ways and may include other or different elements. For example, computer device 102 may include one or more output devices, modulators, demodulators, encoders, decoders for processing data and/or like components.

A bus 116 permits communication among the components of the system 100. The processor component 106 includes processing logic that may include a microprocessor or application specific integrated circuit (ASIC), a field programmable gate array (FPGA), or the like. The processor 106 may also include a graphical processor (not shown) for processing instructions, programs or data structures for displaying a graphic, such as a three-dimensional scene or perspective view.

The data store 104 may include a random access memory (RAM) or another type of dynamic storage device that stores information and instructions for execution by the processor 106, read only memory (ROM) or another type of static storage device that may store static information and instructions for use by processing logic, a flash memory (e.g., an electrically erasable programmable read only memory (EEPROM)) device for storing information and instructions, and/or some other type of magnetic or optical recording medium and its corresponding drive. The data store 104 includes financial account data 105 that is related to one or more user accounts stored and maintained by the server 102 according to customary banking regulations/operations.

Input component 108 includes one or more mechanisms that permit a user to input information to the server 102, such as microphone, keypad, control buttons, a keyboard, a gesture-based device, an optical character recognition (OCR) based device, a joy-stick, a virtual keyboard, a speech-to-text engine, a mouse, a pen, voice recognition, biometric mechanisms, etc. The input component 108 also includes other communication mechanisms for communication between the server 102 and a client device (not show) for conducting banking operations or banking transactions on the server with financial accounts stored on the data store 104. For example, one or more transceivers or wireless connections or ports are incorporated into the input component for transmitting and receiving communication data.

The intelligence component 108 includes varies forms of logic and logical algorithms that compile banking data and provide various transactional related functions to the client for conducting financing and financing services with the server 102. For example, portfolio and stock analysis operations and transactions related to the operations are compiled and used to present various options for transactions that a client may desire. Some operations can provide recommendations, historical and future perspective based on fuzzy logic or other rule based logical algorithms.

The authentication factor component 112 includes algorithms, state based tables, and the like for generating factors that operate to indicate each remote device as authenticated for interfacing with the server 102 and the data store 104 communicatively connected to the server 102. In order to use a client device, such as a mobile device (e.g., mobile phone, wireless laptop, personal digital assistant, iPod, and the like) for online banking transactions on the server 102, for example, a client provides some information such as a phone number or some other address of the mobile client device to the bank. The phone number or contact address, for example, can be provided during registration of the account, when opening the account, or at some other device registration period, in which certain authentication factors unique for the device being used may be provided for installation. For example, a client device identification and a secret key specific to the client device is stored onto the client mobile device to generate further transaction requests related to the client's accounts online. Afterwards, the device is authenticated for security and authorization procedures can follow. Also, a certificate from a certificate signing request that is signed against a private key may be communicated to the client mobile device over a Hypertext Transfer Protocol Secure (HTTPS), for example.

A code generator 114 provides various codes for security procedures to be implemented in conjunction with the authentication factor component 112. Codes such as hash codes, one-time passwords, biometric markers, and the like are communicated to the client devices and used to facilitate a secure client-server relationship in financial transactions online.

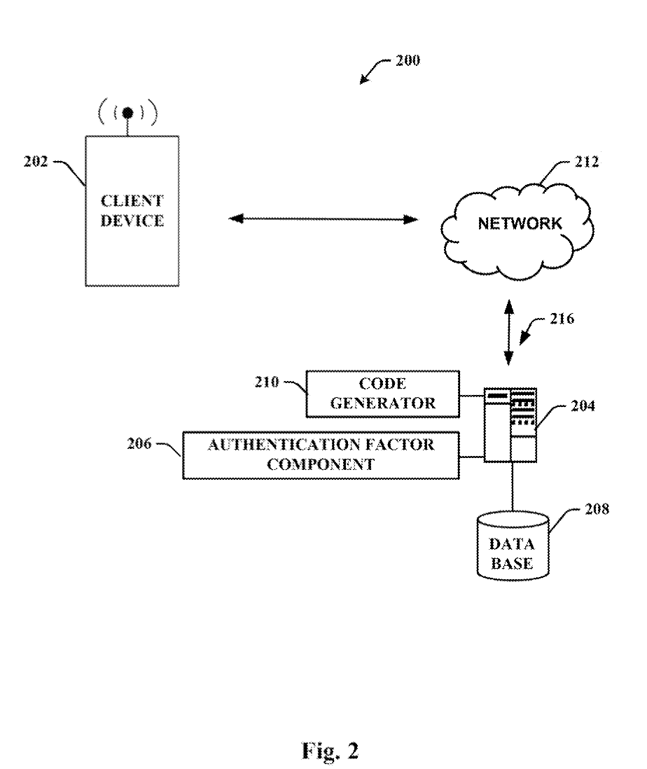

Referring now to FIG. 2, is an exemplary system 200 that enables wireless authentication of a client device 202 (e.g., a client mobile device) without a signature. With financial transactions involving a banking server 204, a transaction request is provided to the server 204 from the client device 202 as input 216 in order to access one or more accounts stored on a database 208. In response to the input 216, a code generator 206 includes logic, algorithms, switches, programmable logic devices, arrays and the like that create various codes to provide to the client device 202. For example, a random number can be generated with a random number generator after the client device 202 is authenticated. The random number (RAND) is then communicated to the client device 202 to enable secured operations to be established with the server 204.

The client device 202 includes a mobile device such as a mobile phone, a personal digital assistant, an iPod, and the like having a web browser for internet browsing or online activity over a network 212. The client device 202 initiates an online transaction request initially with a log-in screen to enter an online account that is maintained by the server 204 on a database or memory storage 208. If the client device 202 is not authenticated for account activity or transaction online with the server 204, an authentication factor component 206 generates initial factors to establish authentication as part of a multi-factor authentication. An authentication factor is a piece of information and synonymic for the process used to authenticate or verify the identity of a person or other entity requesting access under security constraints. The authentication factor component 206 generates at least two unique authentication factors including a first authentication factor that includes client device or mobile device identification and a second configuration factor that includes a secret key, both of which are unique to the particular client device 202. After storing the factors, the client device is able to be used to log-in to a client session on the bank server.

Upon receiving an input 216 that includes a transaction request such as reviewing a history, balance or conducting banking operations involving banking products (e.g., checking, billing, loans, finance, etc.), a code generator 210 generates a code function to be sent to the client device 202. For example, a random number is generated by the code generator 210, which is communicated to the client device 202 and operates as a variable to a different code function on the client device 202. For example, the code generator generates a random code such as a random number or some other alpha-numerical symbol in order to trigger a communication response from the client device to be returned to the server 204 that includes a code generated from the random code variable.

In one embodiment, the client device 202 receives the random code generated by the code generator 210, and in response generates keys with the secret key from the authentication factor component 206 and the random code from the code generator 210. One key, for example, includes a symmetrical key that is used in generation of an encrypted banking message having banking operation data related to a transaction desired by the client. Another key, for example, includes a hash function for device authorization. In response to communicating the random code from the code generator 210, the server 204 receives from the client device 202 a hash function that includes a hash code with the encrypted message, the random number and the secret key. The server 204 uses this data to authorize the device 202 for the transaction by calculating its own symmetrical key using its own stored values for the secret key and random code in order to decrypt the encrypted message and authorize the device for the transaction.

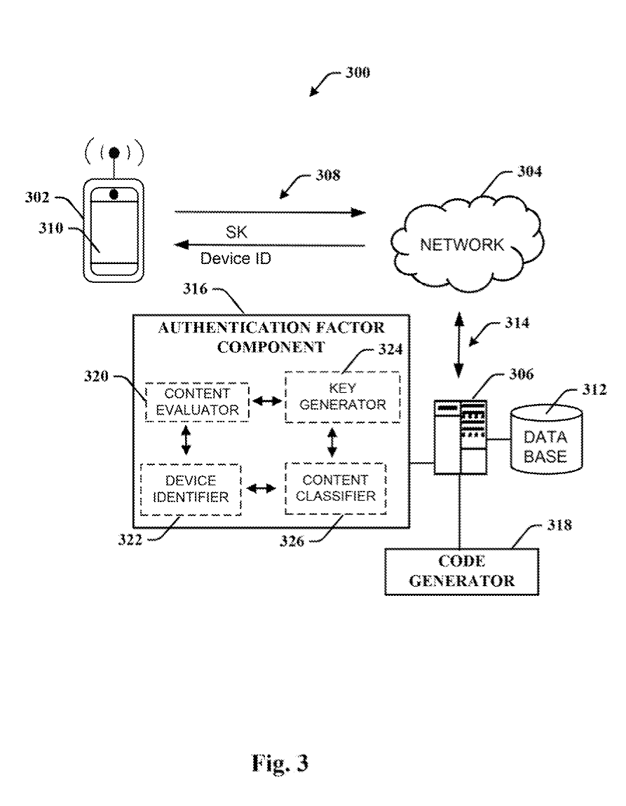

Referring now to FIG. 3, is an exemplary system for authentication of online banking or financial transactions for authorized mobile devices. A client device, for example, includes a mobile device, such as a mobile phone 302 that has a browser for interacting over a network 304, which includes a wide area network, a local area network or some other network for interfacing with a banking server 306. The mobile phone 302 initiates communication over different channels 308, such as with a TCP/IP connection for communication in order to communicate in various means to the banking server 306. The banking server 306 communicates with the mobile phone 302 in a number of different processes. For example, in response to the client device signing on to a log-in screen or attempting to access secured content, conduct a transaction with an account, or some communication request, the banking server 306 generates authentication factors, such as a secret key (SK), a unique client device identifier (Device ID) and a random code to initiate authentication of the client device 302.

The banking server 306 hosts a banking server website and generates a log-in screen 310 for the mobile phone 302 to view and interact with financial account information related to user accounts maintained on a customer financial database 312. The banking server 306 receives a log-in request or a transaction request 314 over the network 304 and determines whether the mobile phone 302 is authenticated and thereby able to conduct a transaction related to a transaction request. Transactions may include operations conducted online with a banking website associated with the banking server 306 that perform a financial transaction such as an account to account transfer, paying a bill, a wire transfer, investments purchasing or sale, applying for a loan, repayment of enrollments, applying for a new account, etc. Other related operations may also be included on the website secured by the banking server 306, such as viewing online statements, check links, co-browsing, chat, viewing recent transactions, downloading bank statements (e.g., in PDF format), viewing images (e.g., paid checks), etc.

The banking server 306 further includes an authentication factor component 316 that is configured to authenticate the mobile telephone 302 by generating authentication factors to be stored on the mobile phone 302 and receiving a confirmation or other entry from the mobile phone 302. In response to receiving the authentication factors from the authentication factor component 316, the banking server 306 is able to verify the mobile phone 302 upon receiving a transaction request 314. Then, once the banking server 306 receives transaction requests one or more codes are generated by a code generator 318 and the codes are communicated via the network 304 to the mobile device. Each code provides a variable to the mobile device in calculating different keys, such as a hash code function and a symmetrical key.

The authentication factor component 316 includes a content evaluator 320, a device identifier 322, a content classifier 326 and a key generator 324 operatively connected with one another to authenticate and provide authentication levels to a mobile device 302. The content evaluator 320 receives payload information from incoming communications sent by the mobile phone 302. The information received at the content evaluator 320 is analyzed or identified as coming from a device having an authentication level that meets a condition for a predetermined function. When the mobile device 302, meets the condition by falling below authentication criteria, then the content evaluator signals for the phone to receive authentication factors based on the log-in information or other information provided by the user. For example, the mobile device 302 may be verified by providing authentication factors to the mobile phone 302, such as a unique client device identifier to allow the mobile phone 302 to be recognized by the server. Authenticating the mobile after log-in, in one example, provides for the banking server 306 to ensure that only a specific pre-authorized device operated by a specific pre-authorized user can access the financial database 312.

The term authentication describes the process of verifying the identity of a person and/or the mobile device. Authentication is mostly dependent upon the user of the mobile device 302 providing valid identification data followed by one or more authentication credentials (factors) to prove their identity, which is verified by the content evaluator 320 of the authentication factor component 316. Customer identifiers may be a bankcard for ATM usage, or some form of user ID for remote access and unique client device identifiers can be a code generator based on a serial number, customer information that a customer or user provides, such as a mobile device name, or any other identification including graphical images, symbols, number, letters, alpha-numerals, binary numerals and the like. An authentication factor (e.g. PIN, password, identifier, device code, etc.) is unique information linked to a specific customer or device identifier that is used to verify that identity.

Upon receiving from the content evaluator an indication that the mobile device 302 does not meet a level of authentication, the device identifier 322 generates a unique client device identifier and the key generator 324 generates a secret key, which are both communicated to the mobile device 302 via the different communication channels 308. For example, transport layer security or secure sockets layer are cryptographic protocols that can provide communication security over the internet. These protocols, for example, encrypt segments of network connections above the transport layer. In one example, asymmetric cryptography may be utilized for key exchanged and symmetric encryption for privacy, and message authentication codes for message integrity.

The content classifier 326 classifies the content according to banking operations requested or transaction requests. Once a transaction request is received from the mobile device having the unique client device identifier and a secret key stored thereon, the content classifier identifies communication payload as a user and device logged on and that the communication includes a transaction request. The specific transaction can also be classified by the content classifier 326.

Upon receiving a transaction request after a log-in generation and the mobile device has a stored unique client device identifier and a secret key, the code generator 318 generates a cryptographic or random code that includes a random number (RAND). The code generator 318 is configured, for example, to generate a sequence of numbers or symbols that lack any pattern or appear random. The banking server 306 then communicates the random code or sequence having the RAND to the mobile device 302 as a variable for calculating additional keys.

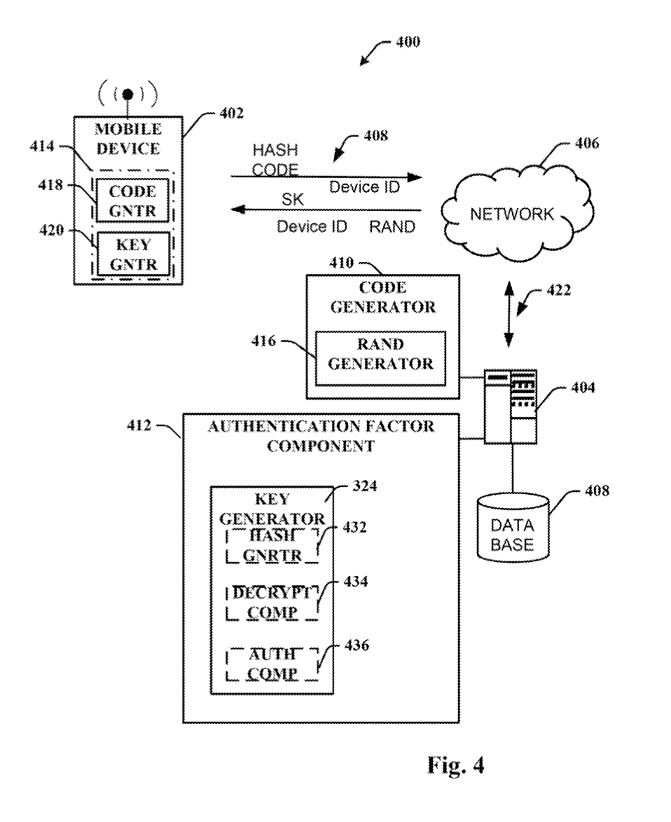

FIG. 4 illustrates exemplary aspects of exemplary systems 400 that manages authentication and authorization of mobile devices to operate banking transactions over networks. A mobile device 402 initiates an authentication and authorization process by communicating log-in information over one or more communication channels 408 on a network 406 to a banking server 404. The banking server 404 is configured to respond to the log-in or other triggering event by determining whether the mobile device 402 is authenticated with the server 404.

The authentication component 412 evaluates the mobile device 402 communications and upon determining that an authentication level of the device falls below a condition for a predetermined function, authentication factors are generated and stored on the mobile device 402. The authentication factors include a first and a second authentication factor, such as a unique client device identifier (Device ID) and a secret key (SK), which may be used for encryption of further communications among the server 404 and the mobile device 402.

The mobile device 402 is configured to communicate a transaction request 422 to the banking server 404, and in response to the request, the banking server 404 provides a random number generated by a RAND generator 416 of a code generator 410. The banking server 404 authorizes a banking session or log-in session by communicating the random number generating by the RAND generator 416 to the mobile device 402. The mobile device 402, in turn, receives the random number over the network 406 along communication channels 408 and calculates at least two keys using the SK and the random number (RAND) as variable in the calculation.

The mobile device 402 includes a cryptographic engine 414 that contains algorithms and/or devices to generate at least two keys, such as a hash code and a symmetrical key (SYMM). The cryptographic engine 414 comprises a code generator 418 and a key generator 420 to respectively generate the hash code and the symmetrical key. The cryptographic engine 414 receives the SK and Device ID from the banking server 404, which are used in authenticating the mobile device for conducting transactions over the network 406, and further receives the RAND in response to an authorized log-in session or a transaction request. The mobile device 402 uses the SK and the RAND as variables to generate the at least two keys (e.g., the hash code and the symmetrical key). The symmetrical code generator 418 generates a symmetrical code (SYMM) that encrypts communications between the mobile device 402 and the banking server 404. The banking operations are conducted to initiate transactions with accounts on the database 408 with data encrypted at the mobile device 402 by using the SYMM.

The code generator 418 further generates a hash code function (HASH CODE) for authorization of the banking operations for the transaction requested in a transaction request from the mobile device 402. The hash code function generated by the code generator 414 maps data sets using hash values in order to provide data comparisons at the banking server 404. The hash function combines an encrypted message having transactional data or banking operations data to instruct the transaction requested by the mobile device 402, and also combines the SK and the RAND. The hash function is then communicated to the banking server 404 with an encrypted message having the transaction request instructions and also with the unique client device identifier.

The banking server 404 with the authentication factor 412 component is configured to receive the encrypted message, the hash function, and the unique client device identifier and calculates a symmetrical key with the values for the secret key provided for authentication and stored on the database 408. The authentication factor component 412 decrypts the message with values for the symmetrical key calculated at the server and upon receiving the hash function and the unique client device identifier from the mobile device 402. The banking server 404 further calculates a hash function with values stored thereat and compares the hash function calculated at the serve with the hash function communicated from the mobile device 402. Based on the comparison the banking server 404 with the authentication factor component 412, the banking server 404 authorizes and executes the transaction. The above process is performed on a per transaction basis, for example, in order to ensure security with mobile devices communicating to the banking server 404. The banking server 404 can also return a confirmation of the transaction executed to the mobile device 402 as well as provide an addition different RAND from the code generator 410 with the confirmation for additional transactions.

In one embodiment, the authentication factor component 412 includes the key generator 324 of the authentication factor component 316 of FIG. 3. As discussed previously, the key generator 324 generates a secret key to be communicated to the mobile device. The key generator 324 further includes a hash code generator 432, a decryption component 434 and an authorization component 436. In response to receiving a hash code function, a unique client device identifier, and an encrypted messaged, the hash code generator 432 calculates a hash code function based on the values for a secret key and a random number stored therein. The decryption component 434 calculates a symmetrical key to decrypt the encrypted message from the mobile device and determine the specific banking transactions requested in the message. The authorization component 436 compares the hash code function calculated at the hash code generator and one received from a mobile device for online activity. Based on the comparison, the authorization component 436 notifies the banking server to authorize the transaction with the mobile device.

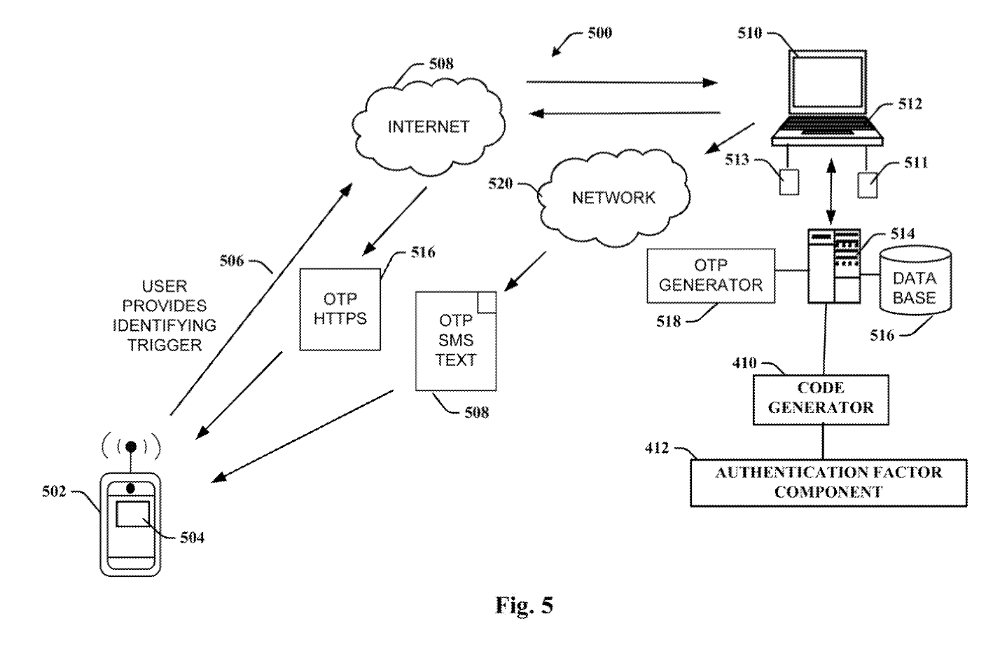

Referring to FIG. 5, illustrated is an authentication system 500 that authenticates a mobile phone for conducting banking transactions with a user account over a wide area network, for example. A mobile device, such as a mobile phone 502 initiates a TCP/IP connection 506 over a wide area network 508 to a computer processing device 512. The mobile device 502 has a phone web browser 504 and a banking application for entering an OTP that is received from the banking server 514. A session or connection with the server 514 is first initiated by a trigger or a request for receiving one or more OTPs, such as an authentication request for conducting online transactions with the user's account via the mobile device 502. The trigger may be an identifying trigger from an initial log-in screen, a request to authenticate a user's phone device for a temporary session, or some other initiating event transmitted to the server 514 to indicate that a mobile device is requiring authentication. In one embodiment, this request for OTPs is accompanied with user identification, phone identification, such as a phone number of the mobile device 502, and/or a password.

The computer device 512 hosts a banking server website and generates a log-in screen 510 with a log-in generator 511 for viewing and interacting with a banking server 514. The computer device 512 further includes an authentication component 513 configured to authenticate the mobile device 502 by receiving a confirmation or other entry from the mobile phone 502. The computer device 512 is configured to receive a request from the client over the cell phone 502 and generates commands to send to the banking server 514 for generating OTPs. An OTP generator 518 is operatively coupled to the banking server and generates OTPs for access to financial accounts stored in a database 516. At least two OTPs are generated by the OTP generator 518 in response to the commands including a first OTP request and a second OTP request. Each OTP, for example, is generated with one another and communicated concurrently to the client device over different channels.

In one embodiment, each OTP generated is identical to the other and communicated from the banking server in response to commands received by the computer device 512. For example, a first OTP 516 that is generated by the OTP generator is sent to a mobile device 502 over the network (e.g., Internet) 508. A second OTP 508 is communicated over a telephony network 520 (e.g., 3G, GPRS, etc.) in a SMS format text message and received as a text at the mobile telephone 502. Each OTP can include one or more numbers, letters, characters, and/or alphanumeric symbols to indicate that a user has obtained a temporary password for conducting an online session for financial transactions with the bank via the browser 504.

The computer device 512 includes a log-in generator 511 that generates a log-in session in HTTPS for interaction by a user of the mobile telephone 502. In response to receiving the OTP text message, a user of the mobile telephone 502 enters the second OTP 508 at a log-in screen 510 that is displayed by the browser 504. Various methods may be implemented for verifying the OTP. Once the server 514 receives the OTP from the user in response to receiving the text 508 with the second OTP, the server then validates a match of the OTP with the OTP sent to the web browser 504. If a match is present, then the server authorizes the client to be authenticated for conducting financial transactions with the phone 502. In one embodiment, the banking server 514 provides a key and a device identifier (as discussed above) to enable log-in to transaction functions and transactions to be authorized. The key can be a secret key for example.

The term authentication describes the process of verifying the identity of a person or entity. Authentication is mostly dependent upon the user of the telephone 502 providing valid identification data followed by one or more authentication credentials (factors) to prove their identity, which is verified by the authentication component 513 according to a match of OTPs, for example. Customer identifiers may be a bankcard for ATM usage, or some form of user ID for remote access. An authentication factor (e.g. PIN or password) is unique information linked to a specific customer identifier that is used to verify that identity. In one embodiment, the user of the mobile telephone 502 receives the second OTP and by entering the OTP manually at a screen in the browser a match is determined and the user is allowed to access transactional functionality related to the accounts stored in the data base 516 by the server 514. In addition, a screen such as a graphical user interface (GUI) screen provides controls for the user to enter into an input control (not shown) displayed in the GUI. The input control receives the second OTP manually entered by the user via an input device such as a keyboard, mouse, voice control, touch screen interface or the like. In response to entering the second OTP having been manually entered, another input control may appear or also require entering alongside the second OTP entered. This input control may be a GUI control such as a drop down menu, a tab control, a matching control or some other GUI for displaying the first OTP. Because the first OTP and the second OTP are identical when transmitted from the banking server 514, the banking server 514 is able to authenticate the mobile telephone 502 by determining that the phone 502 received the second OTP and that the client is not using another phone to enter the information and gain access to the server account stored on the data base 516. One or more other mechanisms may also be used such as returning a text from the phone that received the text in conjunction with log-in information at a log-in screen. A clock may have aided in generating the OTPs and therefore if the text is not received or confirmation at the GUI interface screen is not validated the first OTP may become invalidated for confirmation and the second OTP may provide an invalid match or a match that could not be determined.

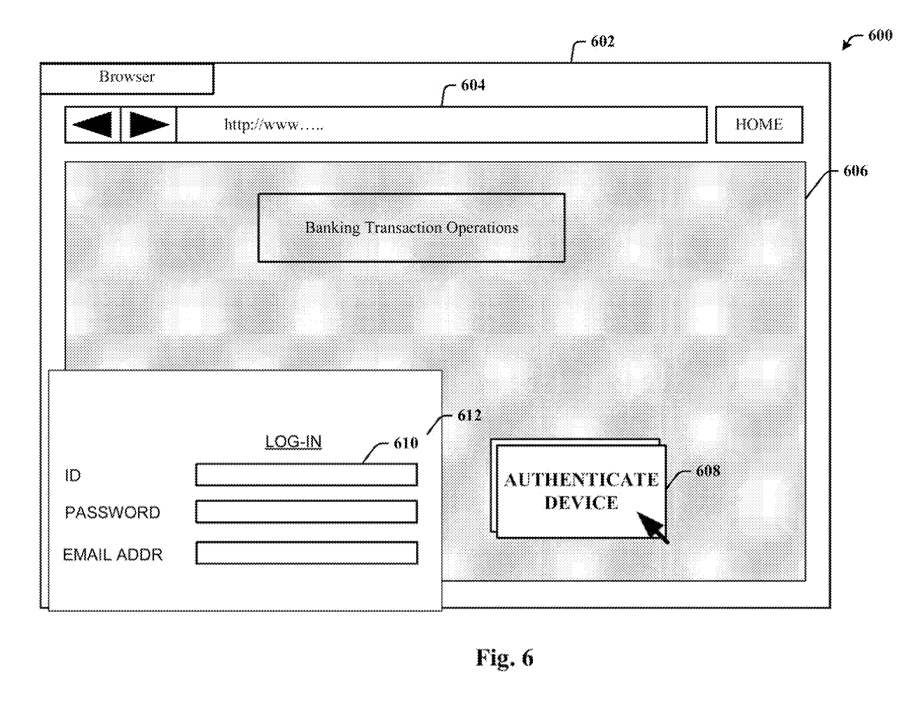

FIG. 6 is an example input viewing log-in screen 600 for a mobile device in accordance with various aspects described herein. The screen 600 is for viewing by a web browser in a mobile device (e.g., a mobile phone, laptop, PDA, etc). As discussed previously, the input viewing log-in screen 300 can be associated with a web browser with a financial database hosted on a banking server. The viewing screen 600 may be a GUI generated by utilizing any one of a number of other technologies, such as Asynchronous, JavaScript and XML, Adobe FLASH and the like. Banking functions for financial transactions on a banking website can be accessed via a web browser that includes an address bar 604 (e.g., URL bar, location bar, etc.). The web browser of the mobile phone can expose an initiation mechanism 608 to initiate authentication of the mobile device (e.g., 402). After a user has logged into the screen the initiation device may trigger the need to authenticate a mobile device for conduction financial transactions on a network. The devices address, telephone number, etc. may or may not already be stored on the database (208, 312, 408, etc). If the contact phone is new or does not have any address information, the user may enter number or SMS address for receiving an OTP from the banking server.

In one embodiment, the initiation mechanism 608 is not utilized and the trigger event may be from an attempt to conduct an online transaction or a log-in session. The screen 300 also includes a log-in screen 612 that may be generated in response to the trigger event (e.g., clicking the initiation mechanism 608, or some other trigger). Device or other Information may also be requested at the log-in screen 612 at additional log-in data input fields 610, such as an ID (e.g., a user ID, biometric identifying information, a facial scan, and the like), a password that includes some secret character combination or symbol sequence stored at the bank for recognizing the ID as belonging to certain financial accounts, an email address, and the like.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

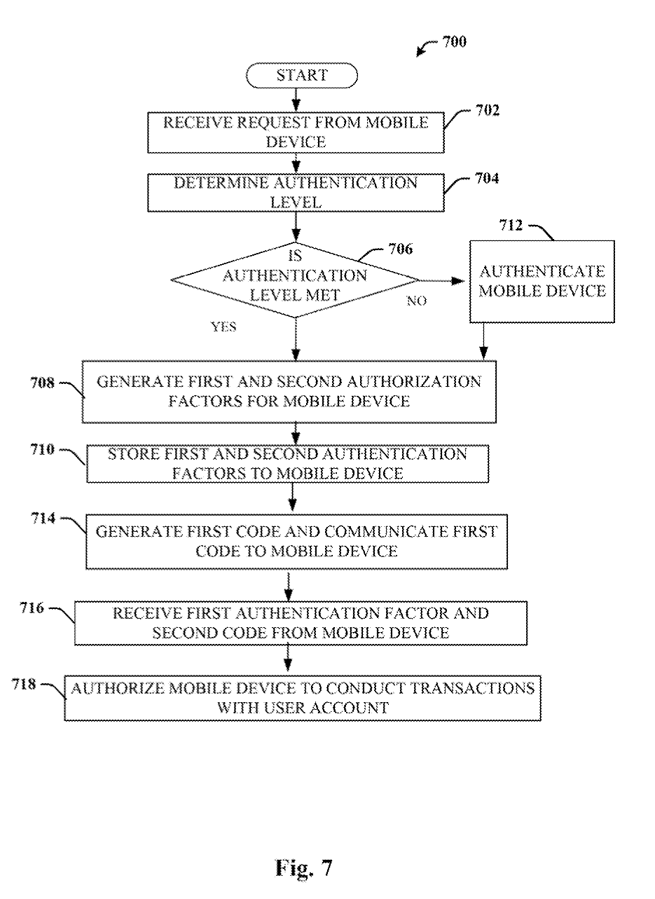

An example methodology 700 for implementing a method for a financial database hosted by a banking server is illustrated in FIG. 7. Reference is made to the figures described above for ease of description. However, the method 700 is not limited to any particular embodiment or example provided within this disclosure.

FIG. 7 illustrates the exemplary method 700 for a system in accordance with aspects described herein. The method 700, for example, provides for authenticating and authorizing a client device of a user for conducting transaction functions related to accounts online with a banking server. At 702, a banking server hosting a financial database that stores financial information related to one or more user accounts receives a request from a mobile device. The request includes a log-in request or transaction request, for example, from a mobile phone or other mobile device. At 704, the banking server determines the authentication level of the mobile device used by the user for the request.

In one embodiment, the authentication level is determined based on receiving a one-time password, as discussed above, and user log-in identification. The user log-in identification can be a password with a user name or a phone number of a mobile device. If the one-time password and the log-in identification match what is stored at the banking server then authentication is approved. The one-time password could be from an HTTPS connection with the mobile device that is entered at a browser of the mobile phone. As discussed above, the one-time password is sent from the server across two different channels, such as by text (SMS) message and to the mobile devices browser via HTTPS. The user of the mobile device enters a one-time password input, which is compared to the one-time passwords sent over two different channels. A match indicates that the mobile phone correctly received the one-time passwords and is subject to approval for transaction functions with the mobile device.

At 706, the banking server determines whether the authentication level meets a condition for a predetermined function (yes or no), where the predetermined function may include certain criteria (e.g., login criteria, device ID is present, session identification, credentials received, etc.).

If the determination is no, then the method flows to 712 where the mobile device is authenticated. The method 700 then flows to 708 as if the determination at 706 is yes. If the determination at 706 is positive (yes), then the method flows to 708 where the device is authenticated and authentication factors (e.g., device identification, session identification, and a secret key) are generated for the mobile device. As discussed above, a first authentication factor includes a unique client device identifier that enables the mobile device to be identified at a banking session. A second authorization factor includes a secret key to calculate codes (e.g., hash codes with encrypted messaging) in the authorization of banking transactions. At 710, the first and second authentication factors are stored to the mobile device by the banking server.

At 714, the server generates and communicates a first code (e.g., random code function or random number) to the mobile device when a session is authorized, such as in response to a log-in request. The first code, for example, is a random code, a random sequence that could include a random number. In addition, a session identifier can be sent to the mobile device for identifying a secure log-in session for conducting transactions.

At 716, the first authentication factor and a second code (e.g., a hash code function) are received from the mobile device. The second code includes a hash code that combines an encrypted message having banking transaction instructions or bank operation data for a requested transaction together with the first code (RAND) and the second authentication factor (SK). The mobile device uses the SK or secret key to generate the second code (hash code function) and a symmetrical key for encrypting the bank operation data in an encrypt message. The server then calculates a symmetrical key with values stored on the server's database for the secret key and random code and decrypts the encrypted messaged. In one embodiment, the server also calculates a hash code function and compares the hash code function with the second code. Based on the comparison, the server authorizes the mobile device to conduct the transaction with a user account. After the transaction is executed, a confirmation is sent to the mobile device with an additional random code encrypted with the secret key to protect from replay attacks.

In other embodiments, a certificate signing request may be received with a public key from the mobile device. In response to a match of the one-time passwords provided and with the one-time password input, the server communicates a mobile device identifier that includes a certificate from the certificate signing request and a signature with at least one key that includes a private key.

In another embodiment, an authorization level is determined at 718 in order to authorize the mobile device to conduct at transaction with at least one user account. The authorization level condition includes decrypting the transaction request with the secret key stored on the banking server. For example, the transaction request could be encrypted with the first hash code. The first random code is obtained with the secret key and the bank operation data is obtained with the random code and the secret key, which include a symmetrical key.

In another embodiment, the server factors its own hash code with values stored on the banking server for the secret key and the first random code. Then, the second hash code and the first hash code that was received from the mobile phone are compared. A match of the first hash code with the second hash code means that the condition is satisfied for an authorization to be granted for a transaction request. In another embodiment, the authorization level determined indicates an authorization of the mobile device in response to the comparison indicating a match of the first hash code with a second hash code, and a validation that the first hash code, a session identifier and the mobile device identifier are received.

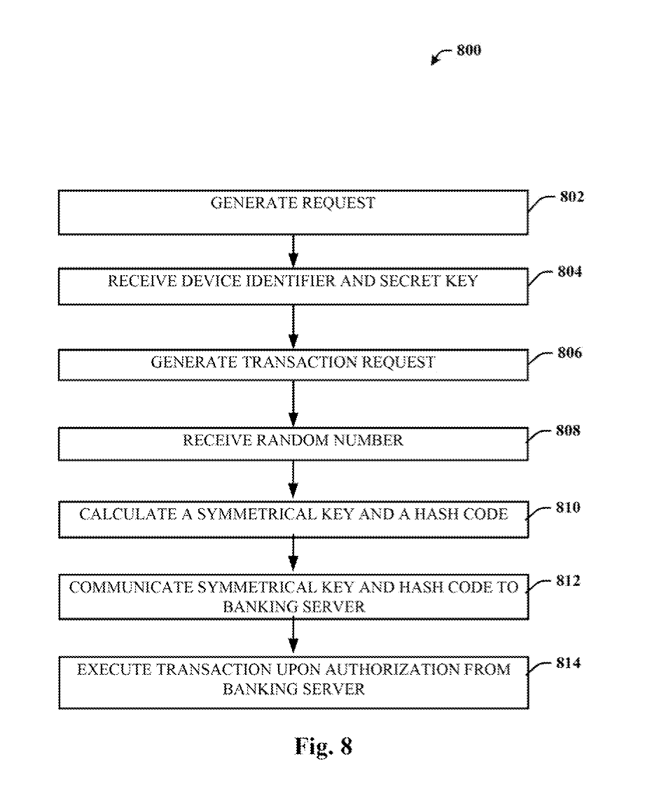

An example methodology 800 for implementing a method for a mobile device that communicates with a server to receive authentication and authorization for online transactions of an account is illustrated in FIG. 8. Reference may be made to the figures described above for ease of description. However, the method 800 is not limited to any particular embodiment or example provided within this disclosure.

At 802, a request or event trigger is communicated to a server from a mobile device. At 804, the mobile device receives a device identifier and a secret for secure online transactions in response to an authentication. At 806, a transaction request is generated to the banking server for executing a transaction. At 808, a random number is received from the banking server in response to the transaction request communicated.

At 810, a symmetrical key and a hash code are calculated by the mobile device based on a combination of the secret key received and the random number. At 812, the symmetrical key and the hash code are communicated to the banking server. At 814, the transaction requested is executed related to at least one user account among one or more user accounts maintained by the server, which is in response to an authorization provided by the banking server based on the encrypted message and the hash code.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

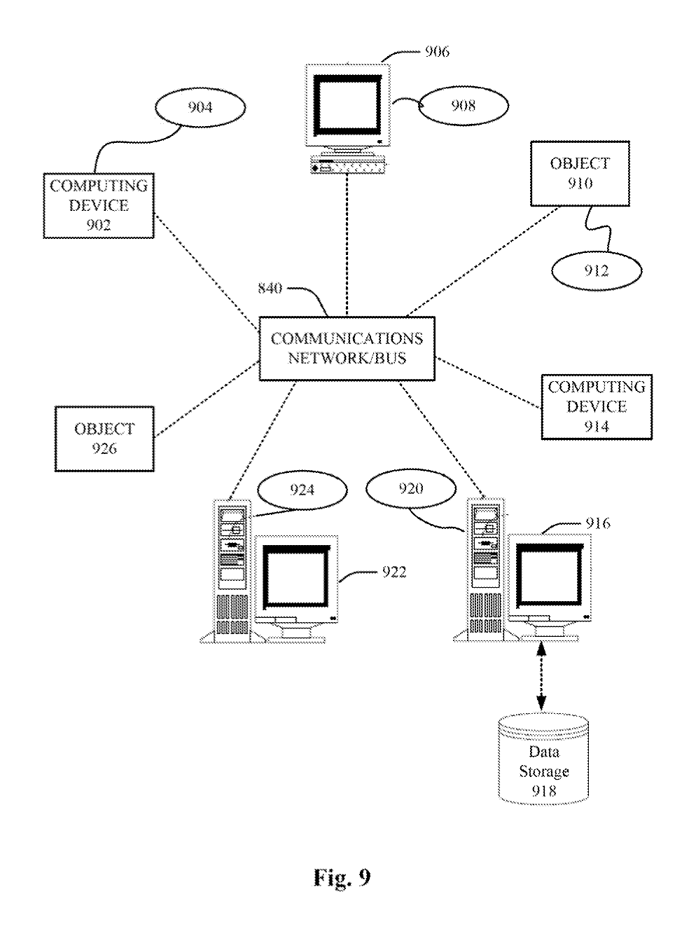

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, communications network 940 may comprise other computing objects and computing devices that provide services to the system of FIG. 9, and/or may represent multiple interconnected networks, which are not shown. Each computing object 910, 912, etc. or computing object or device 920, 922, 924, 926, 928, etc. can also contain an application, such as applications 930, 932, 934, 936, 938, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Exemplary Computing Device

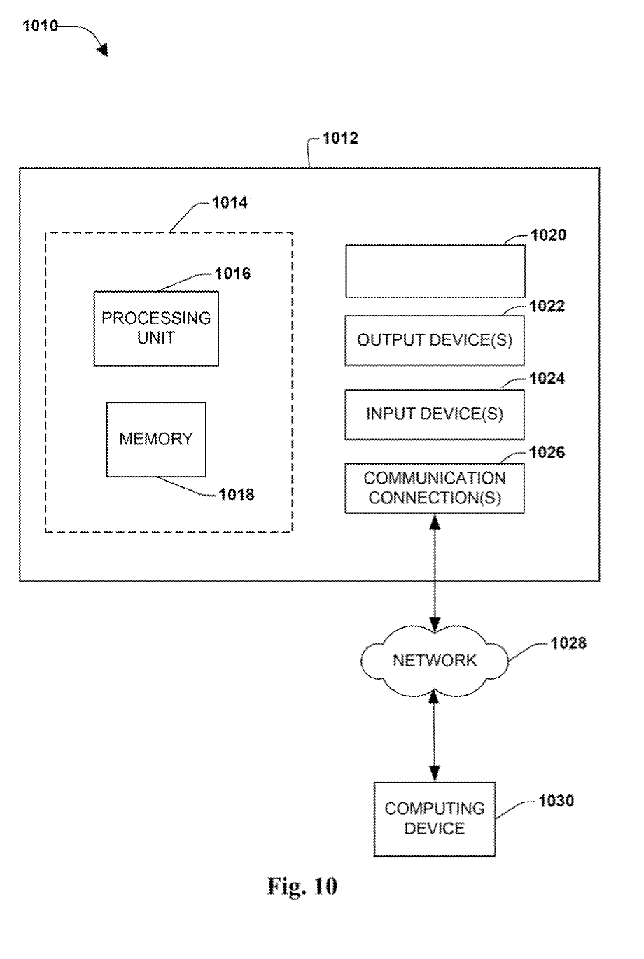

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 10 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method comprising:
determining, at a banking server that stores financial information related to one or more user accounts, an authentication level of a mobile device;
in response to determining that the authentication level of the mobile device meets a condition for a predetermined function, authenticating the mobile device and generating a mobile device identifier and at least one key;
communicating the mobile device identifier and the at least one key to the mobile device;
communicating a first random code and a session identifier to the mobile device in response to validating a log-in request received from the mobile device;
receiving a transaction request having bank operation data;
determining an authorization level associated with the transaction request; and
authorizing the mobile device to conduct a transaction with the one or more user accounts as a function of the authorization level.

2. The method of claim 1, wherein the determining the authorization level further includes retrieving the at least one key with the mobile device identifier.

3. The method of claim 2, further comprises:
decrypting the transaction request with the at least one key stored on the banking server, wherein the transaction request received is encrypted in a first hash code by obtaining the first random code and obtaining the bank operation data from the transaction request with the first random code.

4. The method of claim 3, further comprises:
factoring a second hash code with values stored on the banking server for the at least one key and the first random code and comparing the first hash code and the second hash code, wherein the authorization level determined indicates an authorization of the mobile device in response to the comparison indicating a match of the first hash code with the second hash code.

5. The method of claim 3, wherein the authorization level determined indicates an authorization of the mobile device in response to the comparison indicating a match of the first hash code with a second hash code, and a validation that the first hash code, the session identifier and the mobile device identifier are received.

6. The method of claim 1, further comprising:
receiving, at the banking server, an authentication request from the mobile device having a corresponding telephone number;
generating at least two one-time passwords in response to the log-in request;
communicating the at least two one-time passwords in different respective communication modes to the mobile device; and
validating the mobile device including authenticating the at least two one-time passwords and providing access to transaction functions related the one or more user accounts.

7. The method of claim 6, wherein the generating the at least two one-time passwords at the banking server in response to the log-in request includes communicating a first one-time password in a first communication mode according to a hypertext transfer protocol secure communication protocol to a web browser of the mobile device and communicating a second one-time password in a second communication mode according to a short message service communication protocol to the mobile device, wherein the mobile device is a mobile phone and the first one-time password is identical to the second one-time password.

8. The method of claim 7, wherein the validating the mobile device includes authenticating the at least two one-time passwords by determining a match of a one-time password input, the first one-time password and the second one-time password of the at least two one-time passwords, and in response to the match determined as identical, the banking server provides access to the transaction functions for the transaction request.

9. The method of claim 8, further comprises:
receiving a certificate signing request with a public key from the mobile device; and
in response to the match determined as identical, further communicating the mobile device identifier that includes a certificate from the certificate signing request and a signature with the at least one key that includes a private key; and

10. The method of claim 1, wherein the determining the authorization level includes:
verifying that the transaction request is received with a certificate that is signed with the at least one key stored on the banking server;
validating the first random code received with the transaction request that has the bank operation data; and
communicating a second random code with an operation response to the bank operation data and a different certificate signed with a public key from the mobile device.

11. A computer readable storage medium comprising computer executable instructions that, in response to execution, cause a computing system to perform operations, comprising:
determining, at a banking server that stores financial information related to one or more user accounts, an authentication level of a mobile device;
in response to determining that the authentication level of the mobile device meets a condition for a predetermined function, authenticating the mobile device and generating a mobile device identifier and at least one key;
communicating the mobile device identifier and the at least one key to the mobile device;
communicating a first random code and a session identifier to the mobile device in response to validating a log-in request received from the mobile device;
receiving a transaction request having bank operation data encrypted with a first hash code;
determining an authorization level associated with the transaction request; and
authorizing the mobile device to conduct a transaction with the one or more user accounts as a function of the authorization level.

12. The computer readable storage medium of claim 11, wherein the determining the authorization level further includes determining a symmetrical key with values stored on the banking server for the at least one key and the first random code.

13. The computer readable storage medium of claim 12, further comprises:
decrypting the transaction request with the symmetrical key;
obtaining the first random code and obtaining the bank operation data from the transaction request with the first random code; and
factoring a second hash code with the values stored on the banking server for the at least one key and the first random code and comparing the first hash code and the second hash code.

14. The computer readable storage medium of claim 13, wherein the authorization level determined indicates an authorization in response to the comparison indicating a match of the first hash code with the second hash code.

15. The computer readable storage medium of claim 13, wherein the authorization level determined indicates an authorization in response to the comparison indicating a match of the first hash code with the second hash code, and a validation that the first hash code, the session identifier and the mobile device identifier are received.

16. The computer readable storage medium of claim 13, wherein the log-in request received includes receiving a phone number of the mobile device.

17. The computer readable storage medium of claim 11, further comprising:
receiving, at the banking server, an authentication request from the mobile device of a user having at least one user account of the one or more user accounts;
generating at least two one-time passwords in response to the log-in request;
communicating at least two one-time passwords in different respective communication modes to the user; and
validating the mobile device of the user including authenticating the at least two one-time passwords and providing access to transaction functions related to the at least one user account of the user.

18. The computer readable storage medium of claim 17, wherein the generating the at least two one-time passwords at the banking server in response to the log-in request includes generating the at least two one-time passwords as identical one-time passwords.

19. The computer readable storage medium of claim 18, wherein the communicating the at least two one-time passwords in the different respective communication modes to the user further includes communicating a first one-time password in a first communication mode according to a hypertext transfer protocol secure communication protocol to a web browser of the mobile device and communicating a second one-time password in a second communication mode according to a short message service communication protocol to the mobile device, wherein the mobile device is a mobile phone.

20. The computer readable storage medium of claim 19, wherein the validating the mobile device includes authenticating the at least two one-time passwords by determining a match of a one-time password input, the first one-time password and the second one-time password of the at least two one-time passwords, and in response to the match determined as identical, the banking server provides access to the transaction functions for the transaction request.

21. A system comprising:
a banking server including a customer financial data store having financial information related to one or more user accounts stored on the banking server;
an authentication factor component configured to authenticate a mobile device and provide at least two authentication factors to the mobile device in response to an authentication request from the mobile device; and
a code generator configured to generate a random code in response to a log-in request from the mobile device and communicate the random code to the mobile device,
wherein the banking server is further configured to receive at least one authentication factor of the at least two authentication factors, a transaction request with bank operation data and the random code from the mobile device, to verify the random code received and determine an authorization level of a transaction associated with the transaction request from the mobile device.

22. The system of claim 21, further comprising:
a hash code generator configured to calculate a second hash code function, and provide a comparison of a first hash code function that is received from the mobile device with the second hash code function to determine the authorization level for the transaction.

23. The system of claim 22, wherein the at least two authentication factors include a client device identifier and a secret key, and the authentication factor component is further configured to receive the secret key, the random code and the first hash code function that encrypts the bank operation data from the mobile device.

24. The system of claim 23, wherein the authentication factor component is further configured to calculate a symmetrical key with values stored on the banking server for the secret key and the random code and to decrypt the bank operation data received from the mobile device.

25. The system of claim 21, further comprising:
a one-time password generator operatively coupled to the banking server that is configured to generate one-time passwords, receive control commands from the banking server, and generate a first one-time password and a second one-time password in response to the authentication request,
wherein the banking server is configured to communicate the first one-time password over a first communication pathway to a web browser of the mobile device of a user and to communicate the second one-time password according to a different communication protocol over a second communication pathway to the mobile device of the user.

26. The system of claim 25, wherein the banking server is further configured to communicate the first one-time password over the first communication pathway according to a hypertext transfer protocol secure communication protocol, and communicate the second one-time password over the second communication pathway according to a short message service communication protocol.

27. The system of claim 26, wherein the banking server further comprises a log-in generator configured to generate a log-in screen having input controls that include a one-time password input field and a log-in data input field, wherein the one-time password input field is configured to receive one-time password input from the user, and the log-in request from the mobile device.

28. The system of claim 27, wherein the banking server is further configured to receive the first one-time password, and the one-time password input from the mobile device and determine whether the first one-time password and the one-time password input from the mobile device matches the second one-time password to determine an authentication for the mobile device.

29. The system of claim 28, wherein the banking server is further configured to receive a certificate signing request with a public key from the mobile device; and
in response to determining a match, the authentication factor component is further configured to communicate a certificate from the certificate signing request and a signature with a private key as the at least two authentication factors.

30. The system of claim 29, wherein the banking server is further configured to verify that the transaction request is received with the certificate that is signed with the private key stored on the banking server, to validate the random code received with the transaction request having the bank operation data, and communicate a different random code with an operation response to the bank operation data and a different certificate signed with the public key from the mobile device.

31. A system comprising:
means for determining an authentication level of a mobile phone on a banking server;
means for generating a mobile phone identifier and a secret key that is associated with the mobile phone and storing the mobile phone identifier and the secret key to the mobile phone;
means for authorizing the mobile phone to execute a transaction associated with one or more user accounts that includes means for forming a first random code and communicating the first random code to the mobile phone in response to receiving a log-in request from the mobile phone;
means for receiving the mobile phone identifier and a transaction request with a first hash code from the mobile phone in response to communicating the first random code;
wherein the means for authorizing includes determining an authorization level associated with the transaction that is requested in the transaction request based on a calculation of a second hash code with values stored on the banking server for the secret key and the first random code and a comparison of the first hash code and the second hash code.

32. The system of claim 31, wherein the means for authorizing the mobile phone to execute the transaction with the one or more user accounts provides an authorization in response to the first hash code and the second hash code being a match.

33. The system of claim 32, further comprising:
means for providing a log-in screen having a user identification input control configured to receive a user identification, and a user password input control configured to receive a user password and the transaction request.

34. A method, comprising:
generating an authentication request, by a mobile device, to access at least one user account of one or more user accounts of a banking server and to execute a transaction related to the at least one user account of one or more user accounts;
in response to the authentication request, receiving a mobile device identifier and a secret key that are associated with the mobile device from the banking server;
generating a log-in request to execute the transaction;
in response to the log-in request, receiving a random number from the banking server;
calculating a symmetrical key and a hash code based on a combination of the secret key and the random number;
generating a transaction request with an encrypted message from the symmetrical key;
communicating the transaction request with the encrypted message and the hash code to the banking server; and
executing the transaction related to the at least one user account of one or more user accounts in response to an authorization provided by the banking server based on the encrypted message and the hash code.

35. The method of claim 34, further comprising:
receiving an additional random number with the authorization provided.

36. The method of claim 34, wherein the generating the encrypted message includes generating the encrypted message with bank operation data that relates to the transaction.

37. A mobile device, comprising:
an interface component configured to generate an authentication request and receive, from a banking server, a mobile device identifier and a secret key that are unique to the mobile device in response to the authentication request;
a cryptographic engine configured to generate a hash code and a symmetrical key with a received random number from the banking server and generate a transaction request with an encrypted message; and
a communication module configured to communicate the hash code, the encrypted message and the mobile device identifier to the banking server, and to receive an authorization to execute a transaction in response to the transaction request.

38. The mobile device of claim 37, wherein the cryptographic engine comprises:
a code generator that is configured to combine the encrypted message having bank operation data related to the transaction with the secret key and the received random number to generate the hash code; and
a key generator configured to generate the symmetrical key that encrypts the bank operation data.
